(19) United States
(12) Patent Application Publication
(10) Pub. No.: US 2001/0051693 A1
(43) Pub. Date: Dec. 13, 2001

(54) Method of producing a crosslinked polyester formed-goods

(76) Inventors: Kwan Ho Seo, Taegu-city (KR); Dae Jin Kim, Taegu-city (KR); Ki Ryong Ha, Taegu-city (KR); Hae Jung Kang, Sungnam-City (KR)

Correspondence Address: Shanks & Herbert, TransPotomac Plaza, Suite 306, 1033 N. Fairfax Street, Alexandria, VA, 22314, US

(21) Appl. No.: 09/734,942

(22) Filed: Dec. 13, 2000

(30) Foreign Application Priority Data
Dec. 21, 1999 (KR) 1999-59557

(51) Int. Cl. C08G 63/91; C08G 63/16; C08J 9/00; C08J 3/24; C08K 3/00; C08K 3/34; C08K 5/14; C08L 67/02

(52) U.S. Cl. 525/437; 521/65; 521/82; 528/272; 524/601; 524/424; 524/451; 524/449; 524/450; 524/447; 524/432; 524/433; 524/47; 524/13

(57) ABSTRACT

The present invention relates to a method of producing crosslinked polyester formed-goods characterized by adding 0.005˜10 weight part of organic peroxides against 100 weight part of polyester or polyester mixture.

The present invention is easy to do a forming process, is possible to improve the mechanical property and formability of foamed-goods, and is possible to add the biodegradation and air permeability to formed-goods selectively. The formed-goods of the present invention is used for wrapping film, wrapping container and foaming goods.

### BACKGROUND OF THE INVENTION

1. Field of the Invention

The present invention relates to a preparing method of crosslinked polyester formed-goods that easily enables to do a forming process, and to improve mechanical property of formed-goods and forming ability of foamed substance.

Polyester, being produced industrial purpose currently, is classified diversely by its structure and usage. Since the initial report of invention on preparing method by Whinfield and Dickson of England in the mid of 1940, poly(ethyleneterephthalate)[PET] has been produced in large scale by ICI of England and Dupont of U.S.A. and has been used mainly for fiber and plastic.

Also, poly(butyleneterephthalate) [PBT] is recognized as a important engineering plastic. Recently, polyesters having liquid crystallization have been noticed due to their excellent properties. Among these kinds of polyester, unsaturated polyester is the one which forms final product by crosslinking. Unsaturated polyester, with unsaturate double bond in molecule, is dissolved in styrene as a solvent, and reacts a crosslink reaction by initiator such as peroxides with appropriate catalyst. It is widely used as complex material for ship, vehicle, and construction by adding reinforcement such as glass fiber on the aforesaid resin.

Biodegradable polyester is the one currently highlighted among many kinds of polyesters.

Synthetic plastic, currently used in our usual life, has been required to have good durability than natural polymer because of the necessity for excellent functions. In terms of commercial points of view, researches have been made in the way that this plastic may have more excellent durability in heat, water, light and chemical attack.

Because of these merits, the plastic recognized as a main source of contaminating environment; since the plastic material disposed is not degraded and retains its original shape semi-permanently after its full use.

In most of developed countries, use of non-degradable plastic is prohibited by laws, and researches on developing biodegradable polymer have been devoted a lot.

Biodegradable polymer can be classified by major three shapes. First is starch, starch derivatives, and starch charged plastic. Even though the starch and starch derivative are cheap, it is difficult to commercialize themselves. Because of this reason, starch and starch derivatives are produced in the shape of general purpose polymer with blend. But the blended general purpose polymer has a defect that it shall not be degraded. Second is poly(hydroxybuthylate) [PHB], and poly(hydroxyvalerate) [PHV] produced from micro organism. Even though it has excellent degradation, its usage is limited due to low productivity and property. And the last is aliphatic polyester, a synthetic polymer.

The examples of such aliphatic polyester are polycaprolactone [PCL], polylactic acid[PLA], poly(ethylenesuccinate)[PES] and poly (butylenesuccinate) [PBS].

These biodegradable aliphatic polyester are commercialized only in certain countries such as U.S.A., Japan, England, Italy, etc. These polyester, however, have certain defects that;

its low melt strength derived from a limit in elevating molecular weight during polymerization causes difficulty in its forming, and

its low property such as tear strength during the forming into film.

2. Description of Prior Art

In order to solve the aforesaid problems, many corporations and research centers have contributed much efforts in developing polymerization catalyst and selecting the condition of polymerization. But the practical technique is not invented yet. A Japanese corporation, namely Showa polymer, tried to increase the molecular weight of polymer through several chain extending by adding isocyanate type compound, but it has difficulty in utility due to the problems of forming difficulty and toxic substance occurring during its degradation. The forming difficult is based on a rubber like hehavior due to chemical crosslink during copolymerization.

In the meantime, aromatic polyester such as poly(ethylene terephthalate), poly(buthyleneterephthalate) and aliphatic polyester are used in various purpose like injection molded goods, blow molded goods, fiber, and film since its excellent mechanical property, heat resistance, chemical resistance, and shape stability. When thermoplastic polyester resin is used by extrusion foaming or injection foaming, the resin having low melt viscosity could not capture the foaming gas then the gas shall be scattered, or the generated foam shall not be equal in size and distribution. Because of these reason, it is difficult to commercialize the formed-goods of thermoplastic polyester.

In order to solve these problems, researches have been made on elevating viscosity of polyester by solid polymerization, adding polymerization catalyst, or copolymerization of branch. Yet, the result does not reach to the enough extent of melt viscosity which enables to acquire equal and minute foaming substance.

Thus, the present invention, solving the aforesaid former problems, is to provide a method of preparing polyester formed-goods which has excellency in forming process, enables to improve the mechanical property of formed-goods, to improve the formability of formed-goods, and to allow biodegradable property and gas permeability.

### SUMMARY OF THE INVENTION

The present invention relates to a method of producing a crosslinked polyester formed-goods having excellent forming process.

More particularly, the present invention relates to a method of producing a crosslinked polyester formed-goods characterized by adding 0.005˜10 weight part of organic peroxides against 100 weight part of polyester or polyester mixture in producing polyester formed-goods by injection, extrusion, or compression forming the polyester or polyester mixture.

### DESCRIPTION OF THE PREFERRED EMBODIMENT

The present invention shall be discussed in detail below.

The present invention relates to a method of producing a crosslinked polyester formed-goods characterized by adding 0.005˜10 weight part of organic peroxides against 100 weight part of polyester or polyester mixture before, after or in the mid of process of producing polyester formed-goods.

The aforesaid polyester mixture consist of the polyester and at least one agent selected out of foaming agent, filling agent(herein after we call it as “filler”), as and coloring agent. It is desirable to add less than each of 100 weight part of filler, 5 weight part of coloring agent, 30 weight part of foaming agent against 100 weight part of polyester.

As for the said polyester, poly(hydroxybuthylate), polycaprolactone(PCL), polylactic acid(PLA), polycondensated goods of multivalent acid and multivalent alcohol or mixture of thereof may be used. At this time, aliphatic dicarboxylate acid with structure of HOOC(CH₂)ₙ COOH [n is 2˜10 of integral number] or aromatic dicarboxylate acid such as telephthalic acid may be used for the multivalent acid, and ethylene glycol or buthylene glycol may be used for the multivalent alcohol. Concrete examples of multivalent alcohol are HO(CH₂)₂OH, HO(CH₂)₄OH, HO(CH₂)₅OH, HO(CH₂)₆OH, H(OCH₂CH₂)₂OH, H(OCH₂CH₂)₃OH, O(CH₂OH)₄, or CH₃CH₂ C(CH₂OH)₃ etc.

As for organic peroxides, alkyl peroxides type compound, peroxyesters type compound, diacyl peroxides type compound, peroxyketals type compound or the mixture of the said compounds may be used.

As for alkyl peroxides type compound(R₁—O—O—R₂) di-tert.-butylperoxide, dicumyl peroxide, tert.-butylcumyl-peroxide, bis-(tert.-butylperoxyiso-propyl)- benzene can be applied.

Tert.-butylperoxy benzoate for peroxyesters type compound (R₁CO—O—O—R₂), dibenzoyl peroxide for diacyl peroxides type compound(R₁CO—O—O—OCR₂), 1,1-di-tert.-buthylperoxy-3,3,5-trimethyl cyclohexan for peroxyketal type compound can be applied.

The desirable addition amount of the said organic peroxides is 0.005˜10 weight part against 100 weight part of polyester or its mixture. If the addition amount is less than 0.005 weight part, the crosslink reaction shall be insignificant. And if the addition amount is over than 10 weight part, the forming process shall be deteriorated.

As for filling agent, followings can be applied; calcium carbonate, talc, mica, kaoline, clay, bentonite, zeolite, wood powder, starch, cellulose, zinc oxide, white carbon, magnesium oxide and etc. These filling agent can contribute to the function of the formed-goods, and cost saving. As for coloring agent, organic or inorganic pigment, master batch of pigment and carbon black can be applied.

The present invention does not require special device for the crosslinking the polyester, but it is possible to mix and crosslink by continuous producing equipment such as single screw extruder or twin screw extruder. It makes no difference to crosslink with heat air or steam by conveyor or oven after mixing by the aforesaid equipment.

In the present invention, it is possible to add foaming agent to foam the crosslinked polyester. In this case, followings can be applied as foaming agent;

gas such as N₂, CO₂, Freon;

physical foaming agent such as butane, pentane, neopantane, hexane, isohexane, heptane, isoheptane, methylchloride; or

chemical foaming agent such as azodicarbonamide type compound, P,P′-oxy bis (benzene sulfonyl hydrazide type compound, N,N′-dinitroso pentamethylene tetramine type compound.

The properties of film and formed-goods produced by the polyester of the present invention are evaluated by the following methods:

Percentage of Crosslinking

Put the crosslinked sample in extractor, and extract the non-crosslinked part with solvent for more than 24 hours. Calculate the weight ratio of before and after.

$$Percentage of crosslinking ( \% ) = \frac{weight after extraction ( g )}{weight before extraction ( g )} \times 100$$

Tensile Strength/Elongation

Measurement of tensile strength and shrinkage rate are performed in dumbbell type of KS standard (M 3505) No. 2. Measure the tensile strength and shrinkage rate 7 times respectively per samples, and take the average of 5 times except the highest and lowest value. Use the universal test machine for the measurement of the value. The measurement conditions shall be 100 kgf of load cell, 5 cm of gauge length, and 500 mm/min. of cross head speed. Calculate the tensile strength and shrinkage rate by the below formula after the measurement.

$$Tensile strength ( kgf / {cm}^{′} ) = \frac{maximum load till cutting ( kgf )}{\begin{matrix}thickness of sample ( cm ) \times \\ width of sample ( cm )\end{matrix}}$$

$$Elongation ( \% ) = \frac{\begin{matrix}distance btwn marked when cutting - \\ distance btwn marked before test\end{matrix}}{\begin{matrix}thickness of sample ( cm ) \times \\ width of sample ( cm )\end{matrix}} \times 100$$

Tear Strength

Measurement of tear strength is performed in KS standard M 3505 type. Measure the tear strength 7 times per samples, and take the average of 5 times except the highest and lowest value. Use the universal test machine for the measurement of the value. The measurement conditions shall be 100 kgf of load cell and 500 mm/min. of cross head speed. Calculate the tear strength by the below formula after the measurement.

$$Tear strength ( kfg / cm ) = \frac{maximum load till cutting ( kgf )}{thickness of sample ( cm )}$$

Foaming Ratio

The foaming ratio of foamed polyester shall be calculated by the respective proportion of specific gravities before and after the foaming. The specific gravities before and after the foaming shall be measured by densimeter, which applied the Archimedes' Principles.

$$Foaming ratio ( times ) = \frac{specific gravity before foaming}{specific gravity after foaming}$$

Hardness of Foamed-Goods

Measure the hardness of foamed substance by Asker C Type, a hardness tester. The thickness of sample used for the measurement of hardness is more than 10 mm. Scope of the hardness value shall be 0 at minimum, and 100 at maximum.

The present invention will be discussed more particularly through following examples and comparative examples. The present invention however, does not limited only to these examples:

### EXAMPLES 1˜8 and COMPARATIVE EXAMPLES 1˜2

Add organic peroxide, filling agent, and foaming agent against 100 weight part of poly(butylenesuccinate) [PBS], a polycondensation polymer of butandiol and succinic acid, as shown in Table 1 in super mixer, and prepare the mixture therefrom by blending for 5 minutes at 50° C. Extrude the said mixture through extruder with T-die, and prepare a film or foamed sheet. The measurement results of properties of the samples and foamed-goods is indicated in Table 2.

TABLE 1
Composition ratio of each component

| | | | | Foaming | |
|---|---|---|---|---|---|
| | | Organic | Filler | Agent | |
| | PBS | peroxides | (weight | (weight | Formed |
| Class | (weight part) | (weight part) | part) | part) | type |
| Example 1 | 100 | 1 | 0 | 0 | Film |
| Example 2 | 100 | 2 | 0 | 0 | Film |
| Example 3 | 100 | 3 | 0 | 0 | Film |
| Example 4 | 100 | 4 | 0 | 0 | Film |
| Example 5 | 100 | 1 | 0 | 10 | Foamed |
| | | | | | sheet |
| Example 6 | 100 | 2 | 30 | 10 | Foamed |
| | | | | | sheet |
| Example 7 | 100 | 3 | 30 | 10 | Foamed |
| | | | | | sheet |
| Example 8 | 100 | 4 | 30 | 10 | Foamed |
| | | | | | sheet |
| Comparative | 100 | 0 | 0 | 0 | Film |
| example 1 | | | | | |
| Comparative | 100 | 0 | 30 | 0 | Foamed |
| example 2 | | | | | sheet |

TABLE 2
Measurement result of properties

| | Percentage | Tensile | | Tear | Foaming | | |
|---|---|---|---|---|---|---|---|
| | Of crosslink | Strength | Elongation | strength | ratio | Hardness | Formed |
| Class | (%) | (kgf/cm²) | (%) | (kgf/cm²) | (times) | (Asker C) | Type |
| Example 1 | 35 | 260 | 250 | 230 | — | — | Film |
| Example 2 | 80 | 280 | 290 | 250 | — | — | Film |
| Example 3 | 25 | 330 | 340 | 240 | — | — | Film |
| Example 4 | 65 | 310 | 330 | 250 | — | — | Film |
| Example 5 | — | — | — | — | 10 | 80 | Foamed |
| | | | | | | | sheet |
| Example 6 | — | — | — | — | 18 | 60 | Foamed |
| | | | | | | | sheet |
| Example 7 | — | — | — | — | 25 | 30 | Foamed |
| | | | | | | | sheet |
| Example 8 | — | — | — | — | 28 | 23 | Foamed |
| | | | | | | | sheet |
| Comparative | 0 | 210 | 150 | 180 | — | — | Film |
| example 1 | | | | | | | |
| Comparative | — | — | — | — | 5 | 100 | Foamed |
| example 2 | | | | | | over | sheet |

As it is easy to notice in Table 2, the tensile strength, shrinkage rate, tear strength of film prepared in the condition of examples 1˜4 shows remarkably excellent results when those are compared to the Comparative Example 1, the non-crosslinked one. In Comparative Example 2, non-crosslinked foamed goods, the foaming ratio is only 5 times but the hardness value is over than 100 that cannot be calculated by Asker C. This means that the foamed goods cannot be used as a concussion material.

As for Examples 5˜8, foamed with crosslink polyester, on the other hand, the foaming ratio are high enough to use as concussion material based on the density as low as 0.05˜0.02 g/cm³. Therefore, it can be concluded that it is easy to control the density of foamed goods depends on the contents of foaming agent and organic peroxides.

Since the crosslinked polyester of the present invention does not have the perfect reticulating structure, it has excellent forming process enabling easy process with existing process equipment. In addition, it is possible not only to improve the mechanical property, formability of foamed goods, but also to add the biodegradation and air permeability selectively.

What is claimed is:

1. A method of producing a crosslinked polyester formed-goods, characterized by adding 0.005˜10 weight part of organic peroxides against 100 weight part of polyester or polyester mixture in producing polyester formed-goods by injection, extrusion, or compression forming the polyester and polyester mixture.

2. A method of producing a crosslinked polyester formed-goods as claimed in claim 1, characterized in that said polyester mixture consist of polyester and at least one agent selected out of foaming agent, filling agent and coloring agent.

3. A method of producing a crosslinked polyester formed-goods as claimed in claim 1, characterized in that said polyester is poly (hydroxybuthylate), polycaprolactone(PCL), polylactic acid(P LA), polycondensated goods of multivalent acid and multivalent alcohol or mixture of thereof.

4. A method of producing a crosslinked polyester formed-goods as claimed in claim 1, characterized in that said organic peroxides is alkyl peroxides type compound, peroxyesters type compound, diacyl peroxides type compound, peroxyketals type compound or mixture of thereof.

5. A method of producing a crosslinked polyester formed-goods as claimed in claim 1, characterized in that said filling agent is calcium carbonate, talc, mica, kaoline, clay, bentonite, zeolite, wood powder, starch, cellulose, zinc oxide, white carbon, magnesium oxide or mixture of thereof.

6. A method of producing a crosslinked polyester formed-goods as claimed in claim 1, characterized in that said foaming agent is N₂, CO₂, freon, butane, pentane, neo pantane, hexane, iso hexane, heptane, iso heptane, methylcloride, azodicarbonamide type compound, P,P′-oxy bis (benzene sulfonyl hydrazide type compound, N,N′-dinitroso pentamethylene tetramine type compound or mixture of thereof.

7. A method of producing a crosslinked polyester formed-goods as claimed in claim 1, characterized in that said formed-goods is film, foamed-goods container or sheet type.
